(19) United States
(12) Patent Application Publication
(10) Pub. No.: US 2002/0167814 A1
(43) Pub. Date: Nov. 14, 2002

(54) Portable work light

(76) Inventor: Yueh Ching, Taipei (TW)

Correspondence Address: BACON & THOMAS, PLLC, 4th Floor, 625 Slaters Lane, Alexandria, VA, 22314-1176, US

(21) Appl. No.: 09/752,440

(22) Filed: Apr. 10, 2001

(51) Int. Cl. F21V 21/40

(52) U.S. Cl. 362/399; 362/413; 362/387

(57) ABSTRACT

A portable work light that comprises a light base and a work light; a power switch is installed on said light base or the handle of said work light and the power cord of the work light forms a closed circuit with the power switch, so that when a user holds this portable work light with a single hand, its fingers can also operate the switch to control the power supply to the work light for easy operation.

### FIELD OF THE INVENTION

The present invention relates to a portable work light; specifically to a portable work light with a light base, where handle at the light base or the work light is installed with the power switch, so that the user can single-handedly hold the work light and operate the power switch simultaneously. This feature will provide convenience and utility to the user when using this portable work light.

### DESCRIPTION OF THE PRIOR ART

As shown in FIG. 1, the conventional portable work light is comprised of a light base 3 and a work light 2. Said light is gloved or bolted to the circuitry of said light base, and the user can hold the work light by the handle 1 of the light base by one hand and operate the power switch 4 at the work light with the other hand. However, it is clear that when using the conventional portable work light the user needs to handle it by both hands, one for holding the work light and the other to switch its power on/off. The extra step required in this process hampers the ability of using one of the two hands to engage in other activities. This is especially cumbersome if the user is holding articles with both of his hands, and freeing one of the hands for switching the power on or off can be onerous.

Motivated by progressive and practical considerations, the present invention furnishes a portable work light with said power switch installed on its hand-held handle, so that the user can single-handedly hold the portable work light and operate the power switch with the fingers of the same hand simultaneously. This not only will free up the other hand for other activities but also make the power switch easier to operate.

The primary object of the present invention is to provide a portable work light with light base, where the power switch to the light is installed on the handle at said light base or work light to enable the user to single-handedly hold said work light and operate its switch.

### SUMMARY OF THE INVENTION

To overcome the inconvenience and drawbacks in using the conventional portable work light, the present invention furnishes a portable work light with the power switch installed on the handle at the light base or the work light, such that the user uses only one hand to hold said work light and operate the power switch installed on the handle with the fingers of the same hand, which is a convenient operation. As such, the present invention not only enables total control of the direction of this work light, but also convenient operation of its power switch, which are the primary characteristics.

### BRIEF DESCRIPTION OF THE DRAWINGS

The many strengths and characteristics of the present invention may be further elaborated by the use of following figure:

FIG. 1. A rear view of the convention portable work light.

FIG. 2. A rear view of the portable work light of the present invention.

FIG. 3. A rear view of the portable work light of the present invention in another instance of embodiment.

NUMBERING SCHEME

| | |
|---|---|
| 1 | Handle |
| 2 | Work light |
| 3 | Light base |
| 4 | Power switch |
| 5 | Power cord |
| 6 | Supporting stand |

### DETAILED DESCRIPTION OF THE INVENTION

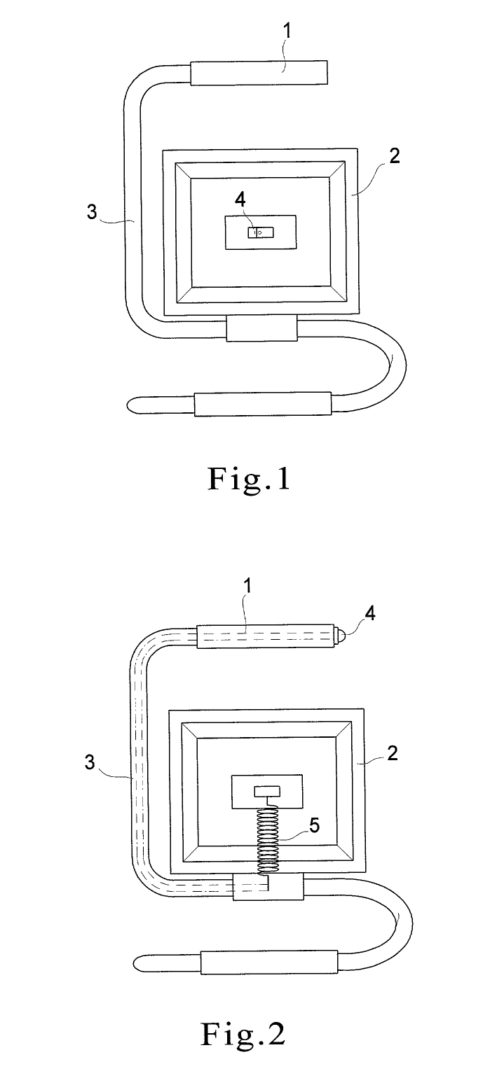

As shown in FIG. 2, the portable work light of the present invention comprises a light base 3, where the power cord 5 for the work light 2 can extend along said light base 3 and form a closed circuit with the handle 1 at the light base 3, and a work light 2 that provides frontal illumination and can be gloved or bolted to said light base 3 to enable the user to single-handedly hold said work light and operate its power switch. In the preferred embodiment of the present invention, when the user holds this work light, he can use the same holding hand to operate the on/off switch installed on the handle 1, and because the power cord 5 from the work light 2 forms a closed circuit with said switch, said switch can turn on/off the power to said work light 2.

In the preferred embodiment, the light base 3 of said portable work light can be a hollow tube structure; the switch is installed on the lateral side of the handle 1, so that the power cord of said work light 2 can form a closed circuit with the switch on the handle 1 via the hollow tube, and thus allows operation of the power switch on handle 1 with a thumb action.

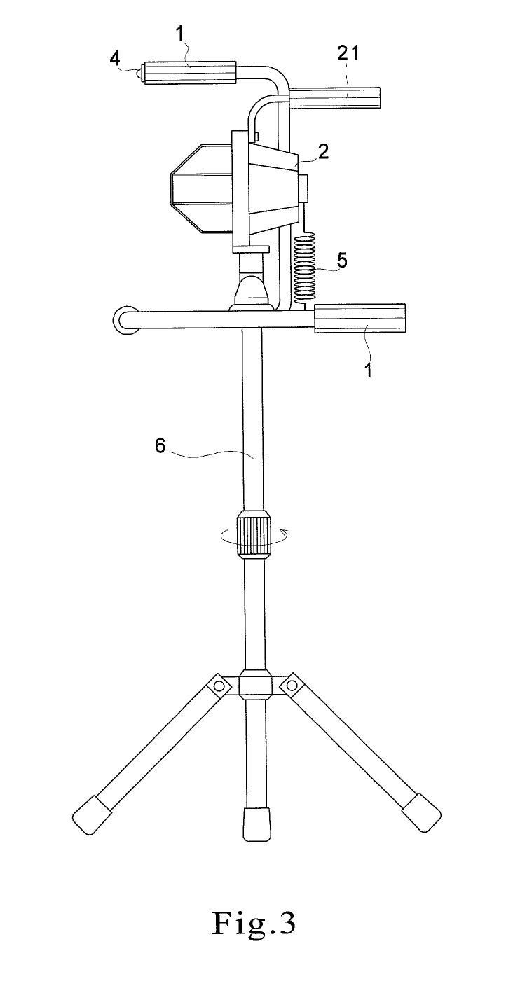

As shown in FIG. 3, the light base 3 of the work light is a supporting stand 6 having a handle 1; said supporting stand 6 can be an adjustable stand that adjusts said work light to the desirable height. At least one work light 2 is installed on said supporting stand; a power switch 4 is installed on said handle 1 and the power cord 5 of the work light 2 forms a closed circuit with said power switch 4, so that when said work light is held by the handle the switch 4 can be directly operated to control the power supply to the work light 2. If necessary, said switch can control the power supply to two work lights. In this modification, each of the work lights 2 installed to the supporting stand is installed with a handle 21 which forms a close circuit with its power cord 5, so that when the work lights 2 are operated individually, each can be held by its handle with a single hand which can also control the power switch to the same work light 2.

In addition, in this embodiment, the power switch 4 of said handle 1 is installed on the lateral side of handle 1 and forms a closed circuit with the power cord 5 of the work light 2, so that the user needs only use a single hand to hold the work light and operate the power switch of the work light 2. Such are the main characteristics of the present invention.

The above thorough exposition of the preferred embodiment of the present invention should enable a person skilled in this technical field to clearly grasp it and undertake various modifications without departing from the scope and spirit of the claims herein. The present invention is not limited to the specific mode of embodiment described herein; for instance, the power cord of the work light extending along the hollow light base to form a closed circuit with the switch of the handle is but one instance of possible embodiment; other modes of the power cord wrapping around the light base are possible. Further, various portable work lights developed for different settings such as for offices, laboratories, schools or industrial settings can all be the subject of the present invention to implement thereon the single-handed operation of controlling the work light's direction and power switch simultaneously.

In conclusion, the present invention possesses many fine features and improves upon the drawbacks and inconveniences associated with the prior art, furnishes an effective solution and delivers a practical and reliable system, which is novel with economical utility and should meet the statutory requirements of a patent.

What is claimed is:

1. A portable work light that comprises a light base and at least one work light; said work light is installed on said light base; said light base forms as a handle and a power switch is installed on said handle; the power cord of said work light can form a closed circuit with said power switch so that said power switch can control the power supply to said work light, which is the characteristic thereof.

2. A portable work light as recited in claim 1, wherein said power cord can extend along the interior of said light base and form a closed circuit with the switch of the handle; and said light base can be a body of hollow interior.

3. A portable work light as recited in claim 1, wherein said switch can be set in at the lateral side of the handle, such that when an user holds the handle by a single hand, its thumb can also operate the switch to control the power supply to said work light.

4. A portable work light as recited in claim 2, wherein said switch can set in at the lateral side of the handle, such that when an user holds the handle by a single hand, its thumb can also operate the switch to control the power supply to said work light.

5. A portable work light as recited in claim 1, wherein the power cord of said work light can wrap on the surface of the light base and form a closed circuit with the switch of the handle.

6. A portable work light as recited in claim 1, wherein said light base is a supporting stand.

7. A portable work light as recited in claim 6, wherein said supporting stand is an adjustable stand that can vary the height of the said work light.

8. A portable work light that comprises a light base and at least one work light; said work light is installed on said light base; said work light is installed with a handle and a power switch is installed on said handle; the power cord of said work light can form a closed circuit with said power switch so that said power switch can control the power supply to said work light, which is the characteristic thereof.
